(19) United States
(12) Patent Application Publication
(10) Pub. No.: US 2003/0115371 A1
(43) Pub. Date: Jun. 19, 2003

(54) Method of setting communication environment between smart card and mobile terminal using layered architecture of protocol stack

(76) Inventors: You Sung Kang, Taejon (KR); Sin Hyo Kim, Taejon (KR); Dae Hun Nyang, Incheon (KR); Byung Ho Chung, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/029,288

(22) Filed: Dec. 28, 2001

(30) Foreign Application Priority Data
Dec. 16, 2001 (KR) 2001-76825

(51) Int. Cl. G06F 9/54; G06F 9/00; G06F 15/163; G06F 15/16

(52) U.S. Cl. 709/310; 709/227

(57) ABSTRACT

A method of setting a communication environment between a mobile terminal and a smart card using a layered architecture of a protocol stack is disclosed. The mobile terminal and the smart card are provided with a plurality of applications and a plurality of applications, respectively, and also provided with a transmission layer for receiving and transferring the data and an application layer for processing the data. The answer-to-reset signal which is a response of the smart card comprises an information on the communication environment supported by the smart card, as well as an information contained in the typical answer-to-reset. Therefore, in case of setting the communication environment between the smart card and the mobile terminal, the communication environment very suitable for the relevant application can be dynamically established, so that a stable communication channel can be promptly provided to a user of the mobile terminal employing the smart card. Since the method according to the present invention can provide the communication environment very suitable for the relevant application, it contributes greatly to the activation of the smart card in the mobile communication.

### BACKGROUND OF THE INVENTION

1. Field of the Invention

The present invention relates to a method of setting a communication environment between a mobile terminal and a smart card using a layered architecture of a protocol stack, and more particularly, to a method of setting a communication environment between a mobile terminal and a smart card using a layered architecture of a protocol stack to rapidly and stably ensure an optimum data transmission speed adapted to each application when a mobile terminal user uses a multi-applications smart card.

2. Background of the Related Art

Generally, smart cards used in mobile and compact terminals are in charge of storing and processing an important information.

Typical smart card has limitations in storing and processing aspects of the information, which are inherent functions, because of the hardware restriction. The hardware restriction exerts on enormous influence on the selection of the data communication speed and the communication protocol between the smart card and the mobile terminal.

In addition, the typical smart card is constructed for a single application because of the above hardware restriction.

A process of selecting the communication speed and communication protocol in the prior smart card system will now be explained with reference to FIG. 1.

FIG. 1 is a schematic view illustrating the process of selecting the communication speed and communication protocol in the prior smart card system.

As shown in FIG. 1, if a smart card 10 is inserted into a mobile terminal 20, the terminal provides power to the smart card (step S101), and typically sends a reset signal to the smart card. The smart card uses the reset signal to reset itself, or to initiate an internal reset function. After reset, the smart card 10 returns an answer-to-reset (ATR) signal to the terminal (step S102).

Generally, the ATR signal is a multi-byte signal including basic information concerning the smart card 10 to the terminal 20, the information comprising communication speed, communication protocol, voltage, electric current, data guard time and the like.

The mobile terminal 20 receiving the ATR signal sends a command of requesting protocol and parameters selection (PPS) to the smart card 10 (step S103), so that it attempts to establish a new communication environment between the smart card 10 and the mobile terminal 20.

If the new communication environment can be established according to the command of requesting the protocol and parameters selection, the smart card 10 sends a signal responding to the command of requesting the protocol and parameters selection to the mobile terminal 20 (step S104). Meanwhile, if the smart card 10 cannot support the request of the protocol and parameters selection of the mobile terminal 20, the smart card 10 is in wait for a new reset.

If the smart card 10 selects the relevant protocol and parameters, the mobile terminal 20 sends a command for opening a logical channel to the smart card under the communication environment with the protocol and parameters selected. In other words, the mobile terminal 20 sends a command for requesting the opening of the logical channel (step S105).

Accordingly, the smart card 10 sends a signal responding to the request of the logical channel opening of the mobile terminal 20 to the mobile terminal 20 (step S1106).

If the logical channel is established between the smart card 10 and the mobile terminal 20 through the above mentioned process, the mobile terminal 20 sends a command for requesting application selection to the smart card 10 (step S107).

The smart card 10 selects the application according to the request of the mobile terminal, and sends a signal responding to the request of the application selection to the mobile terminal 20, thereby completing the initial operation of the application selection.

The process described hereinbefore relates to a general method of selecting the communication speed, the communication protocol, and the application selection relevant to the selected communication protocol in the typical smart card system. In actual practice, however, most typical smart cards are used as a dedicated smart card for only a single application. Therefore, the process of selecting the protocol and parameters is generally omitted.

In addition, since the mobile terminal and the relevant smart card take into consideration of only the dedicated application between them, a program for transmitting a data and a program for driving the application are realized in not a layered form, but an integrated form.

The above method cannot support other high speed of communication environment besides the selected communication speed and communication protocol. Furthermore, there is a disadvantage that the above method cannot be designed to use a number of different application programs.

### SUMMARY OF THE INVENTION

Accordingly, the present invention is directed to a method of establishing an optimum communication environment between a smart card and a mobile terminal that substantially obviates one or more problems due to limitations and disadvantages of the related art.

An object of the present invention is to provide a smart card and a mobile terminal to rapidly and stably establish a communication environment very suitable for each application in a multiple application smart card system.

Another object of the present invention is to provide a smart card and a mobile terminal, in which an application layer and a transmission layer are embodied in the form of a layered architecture to selectively use a communication speed and a communication protocol very suitable for each application in a multiple application smart card system.

Still another object of the present invention is to provide a method of establishing an optimum communication environment between a smart card and a mobile terminal in a multiple application smart card system by sending answer-to-reset signal together with an application information of the smart card and an information, such as a communication speed, a communication protocol or the like, for supporting each application.

To achieve the object and other advantages, the present invention is characterized in that a mobile terminal and a smart card includes a layered architecture of a protocol stack, respectively, and the application layer of the smart card and the mobile terminal includes a plurality of applications capable of being switched to each other, and that the smart card sends an answer-to-reset signal comprising an information on a communication environment, which can be supported by the smart card itself, to the mobile terminal, and the mobile terminal receives and analyzes the answer-to-reset signal to establish the optimum communication environment required by the application of the mobile terminal.

According to one aspect of the present invention, there is provided a method of setting a communication environment between a mobile terminal and a smart card using a layered architecture of a protocol stack, the system comprising: if the mobile terminal provides power to the smart card, sending an answer-to-reset signal from the smart card to the mobile terminal; determining whether or not the received answer-to-reset signal complies with an answer-to-reset signal pattern required by the mobile terminal; if the received answer-to-reset signal complies with an answer-to-reset signal pattern required by the mobile terminal, analyzing the answer-to-reset signal transferred from the smart card to establish a communication environment very suitable for an application to be used at present; if the optimum communication environment is established, sending a command for requesting to open a logical channel, which is to be used in the application, to the smart card; opening the logical channel in response to the command for requesting to open the logical channel received from the mobile terminal, and sending a signal responding to the command to the mobile terminal; and opening the logical channel to be used in the application to ensure a communication channel between the smart card and the mobile terminal. The answer-to-reset signal transferred from the smart card comprises at least one of a communication speed and a communication protocol, which are supported by the smart cart itself, as well as a voltage, an electric current, and a data protecting range.

In the determining step, if the received answer-to-reset signal does not comply with an answer-to-reset signal pattern required by the mobile terminal, the method further comprising the steps of: determining whether or not a process of a protocol and parameters selection is executed in the mobile terminal; if the mobile terminal executes the process of the protocol and parameters selection, sending a command for requesting to select the protocol and parameters to the smart card; determining whether the process of the protocol and parameters selection is supported by the smart card, which receives the command for requesting to select the protocol and parameters from the mobile terminal; and if the smart card supports the protocol and parameters selection, sending a signal responding to the command for requesting to select the protocol and parameters to the mobile terminal to ensure the communication channel between the smart card and the mobile terminal.

If the smart card does not support the protocol and parameter selection, the smart card is converted into a standby state waiting for a reset signal to be received from the mobile terminal.

The smart card and the mobile terminal comprise a transmission layer for transmitting and receiving a data, and an application layer for processing the data, respectively.

The application layer of the smart card and the mobile terminal includes a plurality of applications, and the transmission layer of the smart card and the mobile terminal includes a plurality of communication environments capable of supporting the plurality of applications of the application layer.

The transmission layer and the application layer are independently embodied to each other, so that one application can be supported by a plurality of communication protocols and one communication protocol can support a plurality of applications.

According to another aspect of the present invention, there is provided a storage medium for executing a method of setting a communication environment between a mobile terminal and a smart card using a layered architecture of a protocol stack, the storage medium capable of being read by a digital processor, and storing a program of commands executed by the digital processor, the program being implemented by types, with the program comprising the steps of: if the terminal provides power to the smart card, sending an answer-to-reset signal from the smart card to the mobile terminal; determining whether or not the received answer-to-reset signal complies with an answer-to-reset signal pattern required by the mobile terminal; if the received answer-to-reset signal complies with an answer-to-reset signal pattern required by the mobile terminal, analyzing the answer-to-reset signal transferred from the smart card to establish a communication environment very suitable for an application to be used at present; if the optimum communication environment is established, sending a command for requesting to open a logical channel, which is to be used in the application, to the smart card; opening the logical channel in response to the command for requesting to open the logical channel received from the mobile terminal, and sending a signal responding to the command to the mobile terminal; and opening the logical channel to be used in the application to ensure a communication channel between the smart card and the mobile terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating the process of selecting the communication speed and communication protocol in a prior smart card system;

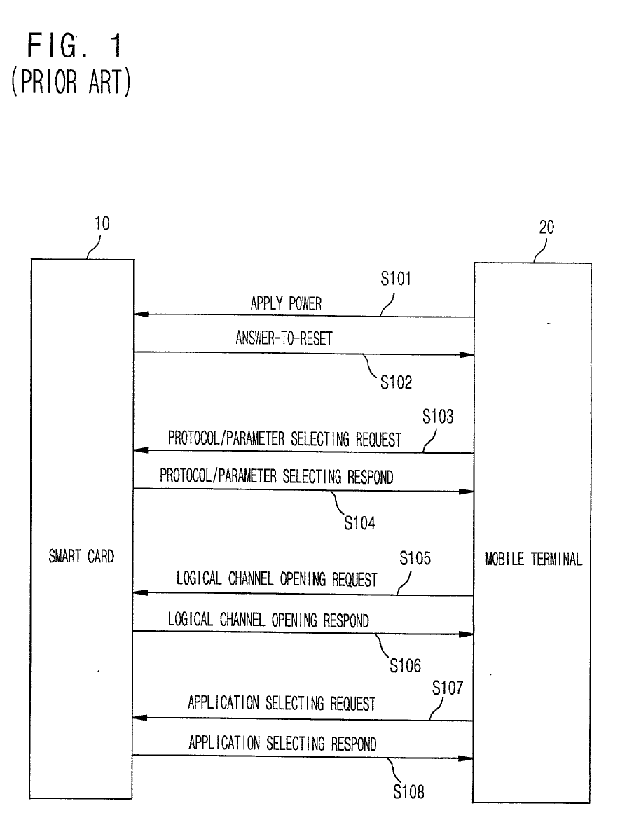

FIG. 2 is a schematic view illustrating the process of determining a communication speed, a communication protocol and a relevant application between a mobile terminal and a smart card using a layered architecture of a protocol stack according to the present invention; and

FIG. 3 is a flowchart of a process of setting an optimum communication environment between the smart card and the mobile terminal according to one preferred embodiment of the present invention.

### DETAILED DESCRIPTION OF THE PREFERRED EMBODIMENTS

The method for setting a communication environment between a mobile terminal and a smart card using a layered architecture of a protocol stack according to one preferred embodiment of the present invention will now be explained with reference to the accompanying drawings.

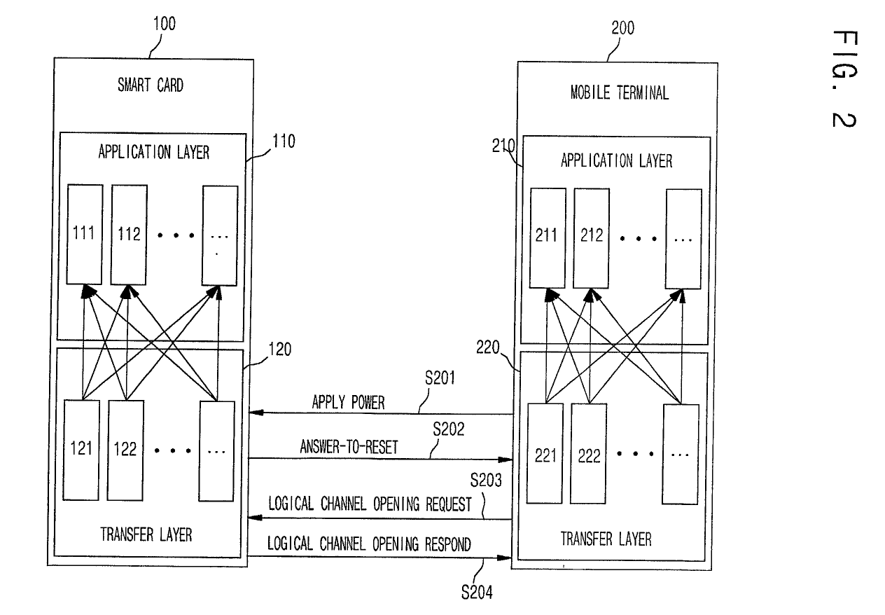

FIG. 2 is a schematic view illustrating the process of determining a communication speed, a communication protocol and a relevant application between a mobile terminal and a smart card using a layered architecture of a protocol stack according to the present invention.

The smart card 100 and the mobile terminal 200 according to the present invention comprise, as shown in FIG. 2, transmission layers 120 and 220 for transmitting and receiving a data, and application layers 110 and 210 for processing the data, respectively.

The above construction is characterized by an advantage of maintaining independence between the layers when certain application changes a communication protocol between the smart card 100 supporting multi-applications and the mobile terminal 200.

Looking through the feature of the operation occurred between the smart card 100 and the mobile terminal 200 with reference to FIG. 2, if a smart card 100 is inserted into a mobile terminal 200, the terminal provides power to the smart card 100 (step S201), and typically sends a reset signal to the smart card.

If the power is applied from the mobile terminal 200 to the smart card 100, after the smart card 100 uses the reset signal to reset itself, or to initiate an internal reset function. The smart card 100 sends an information on a communication environment, which can be supported by the smart card itself, to the mobile terminal 200 (step S202). In other words, after reset, the smart card 100 returns an answer-to-reset (ATR) signal to the mobile terminal 200.

The mobile terminal 200 analyzes the ATR signal transferred from the smart card 100, in other words, the information (for example, communication speed, communication protocol, voltage, electric current, data guard time and the like) on the communication environment transferred from the smart card 100 to determine whether the optimum communication environment concerning the relevant application is established or not.

After the mobile terminal 200 analyzes the communication environment of the smart card 100, the mobile terminal 200 sends a command for requesting to open a logical channel to the smart card 100 to open the logical channel with the smart card 100 (step S203).

Accordingly, the smart card 100 opens the logical channel of the mobile terminal 200 in response to the command for requesting to open the logical channel received from the mobile terminal 200, and sends a signal responding to the command for requesting to open the logical channel to the mobile terminal 200.

An application layer 110 of the smart card 100 includes a plurality of applications 111 and 112, and a transmission layer 120 includes a plurality of communication environments 121 and 122 capable of supporting the plurality of applications of the application layer 110. Also, an application layer 210 of the mobile terminal 200 includes a plurality of applications 211 and 212, and a transmission layer 220 includes a plurality of communication environments 221 and 222 capable of supporting the plurality of applications of the application layer 210.

Unlike the typical smart card system in which one application is operated in only single communication environment, the smart card system according to the present invention can establish a dynamic communication environment between the smart card 100 and the mobile terminal 200, depending upon the selection of the mobile terminal 200.

The feature of dynamically establishing the communication environment has an advantage of reconstructing the communication environment very suitable for a service to be used for one application.

For example, during the first application is used at present, if the second application is driven to search a certain position by accessing to a bank using the smart card, it is desirable to select a communication environment employing a T=0 protocol using a small memory capacity, in order to have no an influence on the first application used at present.

In addition, after accessing to the bank, if the application is no used at present and a data transfer requiring the security such as account transfer is needed, it is desirable to establish a communication environment employing a T=1 protocol supporting a secure messaging.

The mobile terminal of the present invention analyzes the communication environment information of the smart card, which is transferred with an ATR signal, and selects the communication speed and the communication protocol, so that the communication environment very suitable for the present application can be established by selecting the dynamical communication environment as described above.

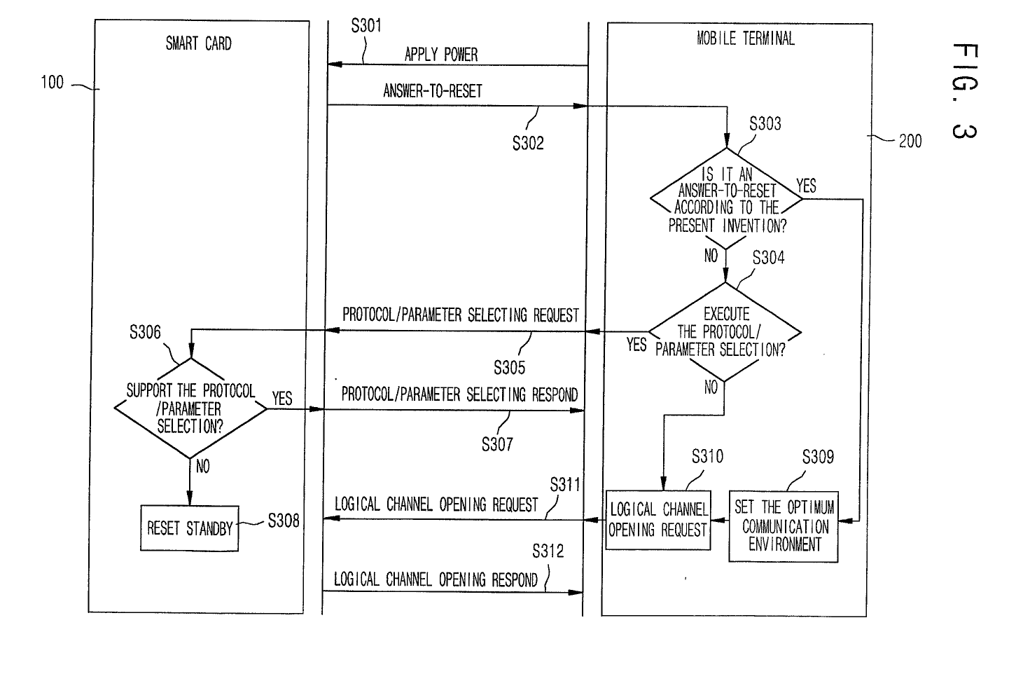

The method of setting the communication environment between the mobile terminal and the smart card employing a layered architecture of a protocol stack according to the present invention will now be explained with reference to FIG. 3.

FIG. 3 is a flowchart of a process of setting an optimum communication environment in the smart card and the mobile terminal according to one preferred embodiment of the present invention.

When a user of the mobile terminal 200 drives the application by use of the smart card 100, the terminal provides power to the smart card.

According to the power from the mobile terminal 200, the smart card 100 sends an answer-to-reset (ATR) signal to the mobile terminal 200 according to the (step S302). The ATR signal comprises the information on a communication environment (in other words, the communication speed and the communication protocol) supported by the smart cart itself, as well as the information related with voltage, electric current, and data guard time.

The mobile terminal 200 receiving the ART signal from the smart card 100 determines whether the received ART signal complies with an ART signal pattern required by the mobile terminal 200 (step S303).

As the result of the above determination, if yes, the mobile terminal analyzes the responding information from the smart card 100 to establish a communication environment very suitable for the application to be used at present (step S309). The information required by the mobile terminal 200 comprises the information on a communication environment (in other words, the communication speed and the communication protocol) supported by the smart cart itself, as well as the information related with voltage, electric current, and data guard time.

If the optimum communication environment is established, the mobile terminal 200 sends a command for requesting to open a logical channel, which is to be used in the relevant application, to the smart card 100 (step S311).

The smart card 100 opens the logical channel according to the command for requesting to open the logical channel received from the mobile terminal 200, and sends a signal responding to the command to the mobile terminal 200 (step S312). Accordingly, the mobile terminal 200 opens the logical channel to be used in the relevant application to ensure a communication channel between the smart card 100 and the mobile terminal 200 (step S310).

In step S303, however, if no, the mobile terminal 200 determines whether a process of a protocol and parameters selection is executed (step S304).

As the result of the above determination, in case that the mobile terminal 200 executes the process of the protocol and parameters selection, the mobile terminal 200 sends a command for requesting to select the protocol and parameters to the smart card 100 (step S305).

The smart card 100 receiving the command for requesting to select the protocol and parameters from the mobile terminal 200 determines whether the process of the protocol and parameters selection is supported by the smart card 100 (step S306).

As the result, if the smart card 100 does not support the protocol and parameters selection, the smart card 100 is converted into a standby state waiting for a reset signal to be received from the mobile terminal 200 (step S308). Otherwise, if the smart card 100 supports the protocol and parameters selection, the smart card 100 sends a response to the command for requesting to select the protocol and parameters to the mobile terminal 200 (step S307).

Therefore, the mobile terminal 200 can ensure the communication channel.

If the protocol and parameters selection is not executed in step S304, the process proceeds to step S310. Specifically, the mobile terminal 200 sends the command for requesting to open the logical channel, which is to be used in the relevant application, to the smart card 100 (step S311). The smart card 100 opens the logical channel according to the command for requesting to open the logical channel received from the mobile terminal 200, and sends the signal responding to the command to the mobile terminal 200 (step S312). Accordingly, the mobile terminal 200 opens the logical channel to be used in the relevant application to ensure a communication channel between the smart card 100 and the mobile terminal 200 (step S310).

As described above, the method according to the present invention can establish the communication environment very suitable for the relevant application between the smart card and the mobile terminal by adopting a new type of answer-to-reset signal, and support the typical communication environment.

According to the method for setting the communication environment between the smart card and the mobile terminal by use of a layered architecture of protocol stack according to the present invention, the mobile terminal and the smart card are provided with a plurality of applications and a plurality of applications, respectively, and also provided with a transmission layer for receiving and transferring the data and an application layer for processing the data. The answer-to-reset signal which is a response of the smart card comprises an information on the communication environment supported by the smart card, as well as an information contained in the typical answer-to-reset. Therefore, in case of setting the communication environment between the smart card and the mobile terminal, the communication environment very suitable for the relevant application can be dynamically established, so that a stable communication channel can be promptly provided to a user of the mobile terminal employing the smart card.

In particular, since the method according to the present invention can provide the communication environment very suitable for the relevant application, it contributes greatly to the activation of the smart card in the mobile communication.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of setting a communication environment between a mobile terminal and a smart card using a layered architecture of a protocol stack, the system comprising:
if the terminal provides power to the smart card, sending an answer-to-reset signal from the smart card to the mobile terminal;
determining whether or not the received answer-to-reset signal complies with an answer-to-reset signal pattern required by the mobile terminal;
if the received answer-to-reset signal complies with an answer-to-reset signal pattern required by the mobile terminal, analyzing the answer-to-reset signal transferred from the smart card to establish a communication environment very suitable for an application to be used at present;
if the optimum communication environment is established, sending a command for requesting to open a logical channel, which is to be used in the application, to the smart card;
opening the logical channel in response to the command for requesting to open the logical channel received from the mobile terminal, and sending a signal responding to the command to the mobile terminal; and
opening the logical channel to be used in the application to secure a communication channel between the smart card and the mobile terminal.

2. The method as claimed in claim 1, wherein the answer-to-reset signal transferred from the smart card comprises at least one of a communication speed and a communication protocol, which are supported by the smart cart itself.

3. The method as claimed in claim 1, in the determining step, if the received answer-to-reset signal does not comply with an answer-to-reset signal pattern required by the mobile terminal, the method further comprising the steps of:
determining whether or not a process of a protocol and parameters selection is executed in the mobile terminal;
if the mobile terminal executes the process of the protocol and parameters selection, sending a command for requesting to select the protocol and parameters to the smart card;
determining whether the process of the protocol and parameters selection is supported by the smart card, which receives the command for requesting to select the protocol and parameters from the mobile terminal; and
if the smart card supports the protocol and parameters selection, sending a signal responding to the command for requesting to select the protocol and parameters to the mobile terminal to ensure the communication channel between the smart card and the mobile terminal.

4. The method as claimed in claim 1, wherein the smart card and the mobile terminal comprise a transmission layer for transmitting and receiving a data, and an application layer for processing the data, respectively.

5. The method as claimed in claim 4, wherein the application layer of the smart card and the mobile terminal includes a plurality of applications, and the transmission layer of the smart card and the mobile terminal includes a plurality of communication environments capable of supporting the plurality of applications of the application layer.

6. The method as claimed in claim 4 or 5, wherein the transmission layer and the application layer are independently embodied to each other, so that one application is supported by a plurality of communication protocols and one communication protocol supports a plurality of applications.

7. A storage medium for executing a method of setting a communication environment between a mobile terminal and a smart card using a layered architecture of a protocol stack, the storage medium capable of being read by a digital processor, and storing a program of commands executed by the digital processor, the program being implemented by types, with the program comprising the steps of:
if the terminal provides power to the smart card, sending an answer-to-reset signal from the smart card to the mobile terminal;
determining whether or not the received answer-to-reset signal complies with an answer-to-reset signal pattern required by the mobile terminal;
if the received answer-to-reset signal complies with an answer-to-reset signal pattern required by the mobile terminal, analyzing the answer-to-reset signal transferred from the smart card to establish a communication environment very suitable for an application to be used at present;
if the optimum communication environment is established, sending a command for requesting to open a logical channel, which is to be used in the application, to the smart card;
opening the logical channel in response to the command for requesting to open the logical channel received from the mobile terminal, and sending a signal responding to the command to the mobile terminal; and
opening the logical channel to be used in the application to ensure a communication channel between the smart card and the mobile terminal.
